(19) United States
(12) Patent Application Publication
(10) Pub. No.: US 2003/0032396 A1
(43) Pub. Date: Feb. 13, 2003

(54) Electronic apparatus and wireless communication system

(76) Inventors: Masahiro Tsuchiya, Komoro (JP); Tsuyoshi Shibuya, Tokyo (JP); Katsuhisa Yabe, Komoro (JP); Kazuhiro Takahashi, Komoro (JP)

Correspondence Address: Mattingly, Stanger & Malur, P.C., 104 East Hume Avenue, Alexandria, VA, 22301, US

(21) Appl. No.: 10/175,308

(22) Filed: Jun. 20, 2002

(30) Foreign Application Priority Data
Aug. 7, 2001 (JP) 2001-238813

(51) Int. Cl. H04B 1/04; H04B 1/02

(52) U.S. Cl. 455/127; 455/120; 455/107

(57) ABSTRACT

The invention is provided to improve the power efficiency of a power amplifier circuit of a wireless communication system having an output transistor that operates in saturation operation mode and linear operation mode. The invention provides an electronic apparatus (module) used for a wireless communication system in which at least an output power amplifiers and an impedance matching circuit are mounted on one insulating substrate and the impedance of the output terminal of the impedance matching circuit is set to 50Ω, wherein a switching circuit that changes the circuit constant of the impedance matching circuit or the high frequency impedance value in view of the impedance matching circuit side from the output power amplifier depending on the operation condition is provided at the point of the impedance lower than the impedance of the output terminal in the impedance marching circuit.

### BACKGROUND OF THE INVENTION

This invention relates to a technique to improve the power efficiency of a power amplifier circuit used for a wireless communication system, and more particularly relates to a technique to improve the power efficiency of a power amplifier circuit in which an output transistor operates in two modes, namely the saturation operation mode and linear operation mode. In detail, for example, the present invention relates to a technique that is effectively applied to a power amplifier circuit of a multi-mode type wireless communication system that involves a plurality of transmission/reception modes such as GMSK (Gaussian filtered Minimum Shift Keying) mode and EDGE (Enhanced Data Rates for GMS Evolution) mode.

The digital communication system has been used most popularly in the field of the cellular phone that is typical of the wireless communication system. Various modulation system such as frequency modulation system, phase modulation system, and time division multiple connection system have been employed as the modulation system in digital communication. Furthermore, the dual mode communication apparatus that communicates, for example, the audio signal by means of GMSK modulation system in which the waveform of a transmission signal is shaped by a gauss type filter at first and the phase of the carrier wave is shifted correspondingly to the transmission data, and the data is communicated at high speed by means of EDGE modulation system in which the amplitude shift is added on the phase shift of the GMSK modulation has been used for the same communication apparatus.

EDGE that is called as GSM384 or UWC-136 employs TDMA (Time Division Multiple Access) as the wireless system. The maximum data transmission speed is 384 Kbps, and this system is suitably used for applications of the video meeting and remote medical care.

### SUMMARY OF THE INVENTION

In the case that one output power amplifier is used commonly for the above-mentioned two modes, in the above-mentioned GMSK mode, because the output power amplifier operates at the full amplitude, the final step output transistor of the amplifier operates in the saturation region, and the output power is relatively as high as approximately 3W. On the other hand, in EDGE mode, because the amplitude of the output is changed, the final step transistor of the output power amplifier operates linearly in the unsaturation region, and the output power is as small as approximately 0.7 W.

The above-mentioned operation mode is switched by changing the bias voltage or bias current of the transistor. However, generally because the efficiency of the amplifier is proportional to the power, in the case of the dual mode communication apparatus involving GMSK and EDGE, the power efficiency is poorer in EDGE mode operation, during which operation the output power is smaller than in GMSK mode operation disadvantageously.

On the other hand, for the conventional mobile communication apparatus that involves the analog communication and digital communication in two ways, an invention involving the power amplifier circuit that is capable of being commonly used for the analog communication and digital communication is proposed (Japanese Published Unexamined Patent Application No. Hei 5(1993)-291842). The prior invention is provided with a power amplifier circuit having an output terminal to which a switching circuit having a capacitor and PIN diode is connected and ON/OFF controlled depending on the communication mode to switch the circuit constant to thereby improve the efficiency in analog mode operation while the linearity is secured in the wide range that is required for digital mode operation.

The inventors of the present invention has developed a technique for switching between GMSK mode and EDGE mode by applying the prior invention, and it is found that the power efficiency in EDGE mode cannot be improved sufficiently.

It is an object of the present invention is to improve the power efficiency of a power amplifier circuit to be used for a wireless communication system having an output transistor that operates both in saturation operation mode and in linear operation mode.

The above-mentioned and other objects and novel characteristics of the present invention will be apparent from the description and attached drawings of the present patent specification.

The outline of typical inventions out of inventions disclosed in the present patent application is described herein under.

In detail, the present invention provides an electronic apparatus used for a wireless communication system in which at least an output power amplifier and an impedance matching circuit are mounted on one insulating substrate and the impedance of an output terminal of the impedance matching circuit is set to 50Ω, wherein a switching circuit that changes the circuit constant of the impedance matching circuit or the high frequency impedance value in view of the impedance matching circuit side from the output power amplifier depending on the operation condition is provided at the point of the impedance that is lower than the impedance of the output terminal in the impedance matching circuit.

Furthermore, the present invention provides a power module in which the final step output transistor of the output power amplifier operates in the first operation mode where the final step output transistor operates in the saturation region and in the second operation mode where the final step output power transistor operates in the linear region, wherein a switching circuit that changes the circuit constant of the impedance matching circuit or the high frequency impedance value in view of the impedance matching circuit side from the output power amplifier depending on the operation condition is provided at the point of the impedance that is lower than the impedance of the output terminal in the impedance matching circuit.

According to the above-mentioned means, because the circuit constant of the impedance matching circuit is switched depending on the operation mode and the load on the output transistor is switched to a value that is suitable for the saturation operation when the output transistor is operated in the saturation operation mode and switched to a value that is suitable for the linear operation when the output transistor is operated in the linear operation mode, the efficiency of the power amplifier is improved thereby.

### BRIEF DESCRIPTION OF THE DRAWINGS

FIG. 1 is a block diagram showing an exemplary front end that is suitably used for a dual-mode cellular phone that is capable of transmission/reception in two modulation systems, namely GMSK and EDGE.

FIG. 2 is a circuit structure diagram showing one example of an RF power module including an output power amplifier HPA and an impedance matching circuit MN shown in FIG. 1.

FIG. 3 is a circuit diagram showing a detailed exemplary circuit structure of the final amplifier Q3 of the RF power module, impedance matching circuits MN4 and MN5, and the constant switching circuit 410 shown in FIG. 2.

FIG. 4 is a circuit diagram showing another exemplary structure of the constant switching circuit 410.

FIG. 5 is an explanatory diagram showing a detailed exemplary structure of the impedance matching circuit MN4 shown in FIG. 3.

FIG. 6 is an equivalent circuit diagram showing a circuit model used to verify the operation of the exemplary circuit and the circuit of the prior invention.

FIG. 7 is a Smith chart showing the phase characteristic of respective impedances based on the simulation result obtained when the capacitance of the exemplary circuit and the circuit of the prior invention is changed.

FIG. 8 is a map on which the contour lines of the power efficiency and the contour lines of leak power to the adjacent channel in EDGE mode obtained when the capacitance C3 or C5 is equalized to 0 in the equivalent circuit shown FIG. 6 are drawn in the form of Smith chart.

FIG. 9 is a graph showing the respective power efficiencies obtained by actual measurement in the case that the capacitance C5 is changed in a range from 0 to 3 pF at the constant capacitance C3 of 0 (model that is equivalent to the circuit of the prior invention) and in the case that the capacitance C3 is changed in a range from 0 to 3 pF at the constant capacitance C5 of 0 (model that is equivalent to the exemplary circuit of the present invention).

FIG. 10 is a graph showing the respective EVM values obtained by actual measurement in the case that the capacitance C5 is changed in a range from 0 to 3 pF at the constant capacitance C3 of 0 (model that is equivalent to the circuit of the prior invention), and in the case that the capacitance C3 is changed in a range from 0 to 3 pF at the constant capacitance C5 of 0 (model that is equivalent to the exemplary circuit of the present invention).

FIG. 11 is a graph showing the respective ACPR values obtained by actual measurement in the case that the capacitance C5 is changed in a range from 0 to 3 pF at the constant capacitance C3 of 0 (model that is equivalent to the circuit of the prior invention), and in the case that the capacitance C3 is changed in a range from 0 to 3 pF at the constant capacitance C5 of 0 (model that is equivalent to the exemplary circuit of the present invention).

FIG. 12 is a Smith chart for describing the principle of the phase change of the impedance Z1 in view from the output power amplifier in the model that is equivalent to the circuit of the prior invention.

FIG. 13 is a partially cross sectional perspective view showing an exemplary device structure of the RF power module shown in FIG. 1.

FIG. 14 is a bottom view showing an exemplary structure of the back side of the exemplary module.

### DETAILED DESCRIPTION OF THE PREFERRED EMBODIMENTS

Preferred embodiments of the present invention will be described in detail hereinafter with reference to the drawings.

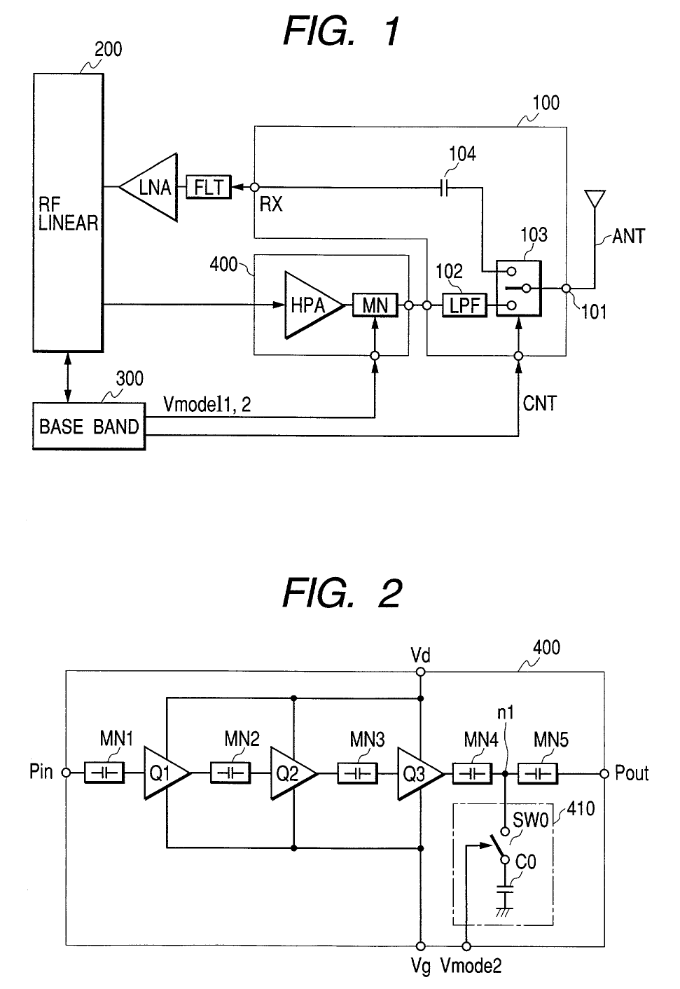

FIG. 1 shows an example of a front end section that is suitably used for a dual-mode cellular phone that is capable of transmission/reception by use of two modulation systems, namely GMSK and EDGE.

In FIG. 1, ANT denotes a signal wave transmission/reception antenna, 100 denotes an antenna switch module having a built-in switch for switching between transmission and reception, FLT denotes a filter for removing noise from a received signal, LNA denotes a low-noise amplifier for amplifying a received signal, HPA denotes an output power amplifier, MN denotes an impedance matching circuit, 200 denotes a high frequency processing circuit for down-converting and modulating a received signal to an intermediate frequency signal to generate a base band signal or for modulating a received signal, and 300 denotes a base band circuit for converting an audio signal to a base band signal or for converting a received signal to an audio signal.

In the present patent specification, an integrated component in which a plurality of electronic apparatus are mounted on one insulating substrate such as a ceramic substrate having printed wiring on the surface and in the internal thereof and the electric parts are connected by means of the printed wiring and bonding wire so as to function as desired respectively is called as a module because such integrated component functions as one single electronic apparatus.

In the present example, the output power amplifier HPA and the impedance matching circuit MN are mounted on one ceramic substrate so as to serve as a high frequency power amplifier module (referred to as RF power module hereinafter) 400 separately, though it is not limited particularly.

The antenna switch module 100 is provided with an antenna terminal 101, a low-pass filter 102 for attenuating the higher harmonic wave included in a received signal, a transmission/reception switch 103, and a capacitance 104 for cutting a DC component from a received signal. The high frequency processing circuit 200 that is capable of modulation and demodulation in two modulation systems, namely GMSK and EDGE, is provided with one or more semiconductor integrated circuit. The base band circuit 300 is provided with a plurality of LSI and IC such as a DSP (Digital Signal Processor), a microprocessor, and a semiconductor memory.

The antenna switch module of the present example is provided with the terminal 101 having the impedance of 50Ω to which the transmission/reception antenna ANT is connected. The impedance of the input terminal and the output terminal of the low-pass filter 102 and the transmission/reception switch 103 is also adjusted to be 50Ω. The matching circuit MN functions to convert the impedance of the output power amplifier HPA having an impedance lower than 50Ω to thereby match it with the impedance (50Ω) of the input terminal of the antenna switch module 100. The transmission/reception switching circuit 103 is switched in response to a switching control signal CNT supplied from the base band circuit 300, though it is not limited to the case.

FIG. 2 shows an exemplary structure of an RF power module 400 that includes the output power amplifier HPA and impedance matching circuit MN shown in FIG. 1.

As shown in FIG. 2, the RF power module 400 of the present example is provided with an amplifier having three-step structure Q1, Q2, and Q3, an impedance matching circuit Mn1 interposed between an input terminal Pin and the first amplifier Q1, impedance matching circuits Mn2 and Mn3 interpolated between amplifiers Q1 and Q2 and between amplifiers Q2 and Q3 respectively, impedance matching circuit Mn4 and Mn5 interpolated between the final amplifier Q3 and an output terminal Pout, and a constant switching circuit 410 comprising a switch SW0 and a capacitance element C0 connected to a connection node n1 between Mn4 and Mn5.

The switch SW0 is structured so as to operate ON/OFF depending on the control voltage Vmode2 supplied from the base band circuit 300. Out of the above-mentioned Q1 to Q3, Q1 and Q2 are structured as one IC (integrated semiconductor circuit) and Q3 is structured as a separate IC, though it is not limited to the case particularly.

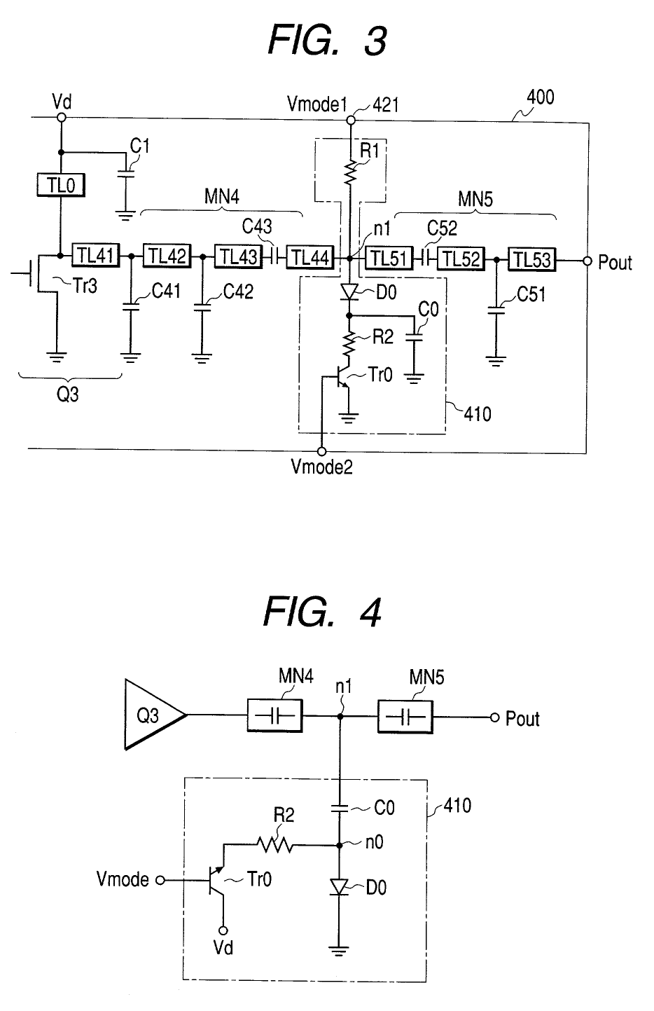

FIG. 3 shows a detailed exemplary circuit structure of the final amplifier Q3 of the RF power module shown in FIG. 2, impedance matching circuits MN4 and MN5 disposed on the rear end thereof, and the constant switching circuit 410. A received signal amplified by means of the front end amplifier is supplied to the gate terminal of a transistor Tr3 that is the output transistor of the final amplifier Q3, a power source voltage Vd is applied on the drain terminal through a λ/4 transmission line path TL0 having an electric length of ¼ wavelength of the fundamental wave, and the impedance matching circuit MN4 is connected to the connection node between the λ/4 transmission line path TL0 and the drain terminal of the transistor Tr3. The TL0 may not be λ/4 line path but may be a coil inductance.

Though it is not limited to the case, in the present example, the impedance matching circuit MN4 comprises transmission line paths TL41, TL42, TL43, and TL44, capacitance elements C41 and C42, and a capacitance element C43 for cutting the DC component. Furthermore, the impedance matching circuit MN5 comprises transmission line paths TL51, TL52, and TL53, a capacitance element C51, and a capacitance element C52 for cutting the DC component, and the constant of the circuit is set so that an impedance of the output terminal Pout is adjusted to be 50Ω finally.

Though a MOSFET is used as the output transistor Tr3 in the example shown in FIG. 3, another type of transistor may be used instead of the MOSFET, and a bipolar transistor, GaAsMESFET, hetero-junction bipolar transistor (HBT), HEMT (High Electron Mobility Transistor) may be used.

The constant switching circuit 410 comprises a resistor R1 connected between the first control terminal 421 and the connection node n1 between the transmission line paths TL44 and TL51, a diode D0, a resistor R2, a transistor Tr0 that are connected in series between the node n1 and a constant potential point such as the earth potential point, and a capacitance element C0 connected between the cathode terminal of the diode D0 and a constant potential point.

A PIN diode D0 is desirably used as the diode D0. The capacitance element D0 having a capacitance of several pF may be used. Resistors R1 and R2 having a resistivity of several kΩ may be used. A bipolar transistor is used as the transistor Tr0 in the example shown in FIG. 3, but a MOSFET may be used instead. In the case that a MOSFET is used as the output transistor Tr3, a MOSFET is used also as the transistor Tr0 and disposed adjacent to the transistor Tr3 to thereby reduce the occupied area.

In the case of the circuit of the present example, the level of the control voltage Vmode2 supplied from the base band circuit 300 is low (for example, 0 V) in GMSK mode. The level of the control voltage Vmodel may be high (Vd) or low (0 V). In such situation, the transistor Tr0 of the constant switching circuit 410 is in OFF state and the current path through the PIN diode D0-resistor R2-transistor Tr0 is shut off. As the result, the impedance of the diode D0 in view from the line through which the transmission signal is transmitted increases, and the capacitance C0 disposed behind the diode D0 cannot be viewed from the transistor Tr3.

Furthermore, because a PIN diode is used as the diode D0, the floating capacitance is negligibly small. Furthermore, because the resistor R1 has a resistance of as high as several kΩ order and the impedance is sufficiently high, the impedance disposed behind the resistor R1 cannot be viewed in high frequency situation. As the result, the RF power module 400 operates as in the case that there is no constant switching circuit 410. In other words, the circuit constant of the RF power module 400 is dependent on the transmission line paths TL41 to TL53 and capacitances C41, C42, and C51.

On the other hand, in EDGE mode, the level of the control voltage Vmode2 supplied from the base band circuit 300 is high (for example, Vd=3.5 V). Also, the level of the control voltage Vmodel is high (however, Vmode1≧Vmode2). In such situation, because the transistor Tr0 of the constant switching circuit 410 is turned ON and a current flows through the PIN diode D0-resistor R2-transistor T0, the impedance of the diode D0 in view from the line through which the transmission signal is transmitted is sufficiently low, and the capacitance C0 disposed behind the diode D0 can be viewed in the high frequency situation.

However, because the resistor R2 has a resistance of as high as several kΩ order in comparison with the transmission line having a resistance of 50Ω and the impedance is sufficiently high, the impedance disposed behind the resistor R2 cannot viewed from the transmission line. Furthermore, because a PIN diode is used as the diode D0, the ON resistance is negligibly small. Therefore, at that time, the RF power module 400 operates as in the case of a circuit having the node n1 to which the resistance C0 is connected. In other words, the circuit constant of the RF power module 400 depends on the transmission line paths TL41 to TL53, capacitances C41, C42, and C52, and capacitance C0.

In the case that the matching circuit MN4 has no capacitance C43 for DC cutting in the constant switching circuit 410 having the structure as shown in FIG. 3, because a potential of the node n1 is applied from the drain of the output transistor Q3, the constant switching circuit 410 can be switched only with the control voltage Vmode2 without the control voltage Vmode1.

The constant switching circuit 410 to be used is by no means limited to the constant switching circuit having the above-mentioned structure, and, for example, a circuit shown in FIG. 4 may be used. The constant switching circuit 410 shown in FIG. 4 comprises a capacitance element C0 and a diode D0 connected in series between a constant potential point and the connection node n1 between the matching circuits MN4 and MN5 and comprises a resistor R0 and a transistor Tr0 connected in series between the connection node n0 formed between the capacitance element C0 and diode D0 and a power source voltage terminal Vd. The diode D0 is not necessarily a PIN diode in this circuit.

When the transistor Tr0 of the constant switching circuit 410 shown in FIG. 4 is turned ON in response to the control voltage Vmode supplied from the base band circuit, a current flows through the transistor Tr0, resistor R0, and diode D0 to thereby adjust the level of the potential of the node n0 to a predetermined level, and the capacitance C0 can be viewed from the line through which the transmission signal is transmitted.

Furthermore, when the transistor Tr0 is turned OFF, the current that has flowed through the resistor R0 and diode D0 is shut off, the potential of the node n0 becomes uncertain (floating) and the capacitance C0 disappeared from the line through which the transmission signal is transmitted. In other words, the constant of the circuit changes depending on whether the transistor Tr0 is in ON state or in OFF state. However, because a slight capacitance is given to the node n1 on the transmission line even in the state that the transistor Tr0 is in OFF state in the case of the constant switching circuit 410 shown in FIG. 4, the constant switching circuit 410 shown in FIG. 3 that has no such capacitance is suitably used.

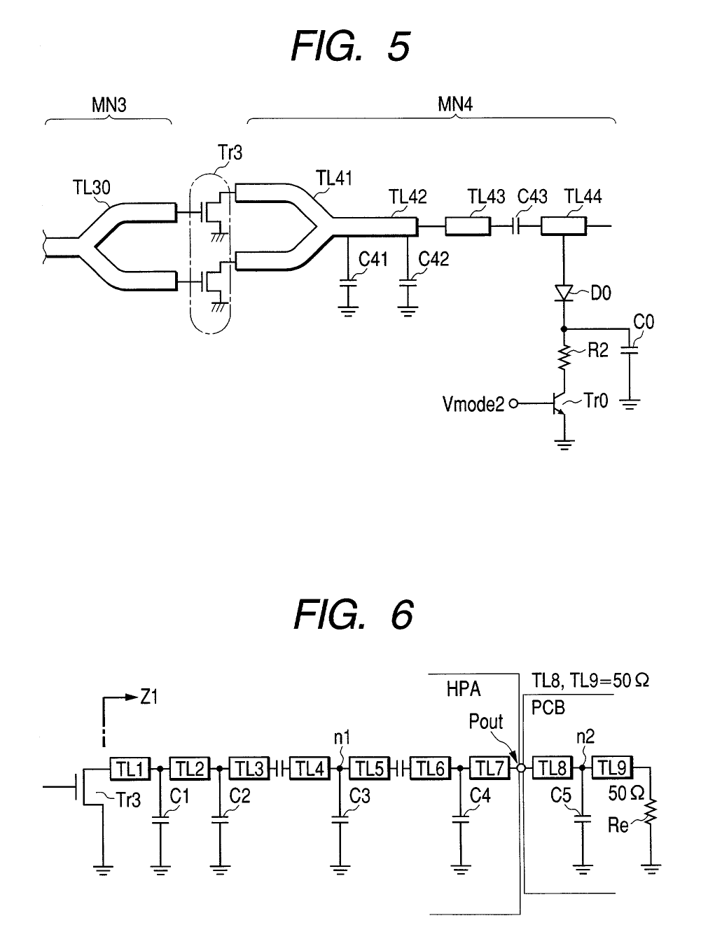

The above-mentioned transmission line paths TL41 to TL44 and TL51 to TL53 comprises a conductive layer called as micro strip line formed on the surface of an insulating substrate that constitutes a module in detail. The transmission line path TL 41 connected to the output transistor Tr3 of the final amplifier Q3 is formed in Y-shaped pattern as shown in FIG. 5, the transistor Tr3 comprises two elements, the drain terminal of each element is connected to the starting terminal of the transmission line path TL41, and the same one signal is supplied to each gate terminal of two elements through the reverse Y-shaped transmission line path TL30 of the front end matching circuit MN3 to operate in parallel. Thereby, the source inductance is reduced to gain the high gain in comparison with the structure in which the output transistor Tr3 comprises one element.

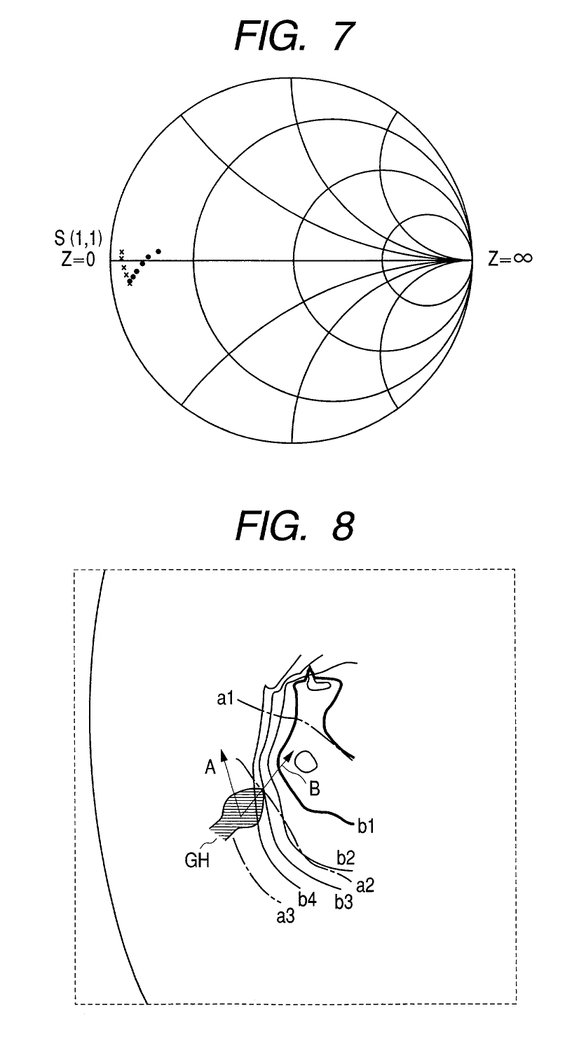

Next, the simulation result carried out to verify the operation of the circuit of the above-mentioned example will be described. In the simulation, a circuit, in which the capacitance C3 is connected instead of the constant switching circuit 410 shown in FIG. 3, the end terminal resistor Re having a resistance of 50Ω is connected with interpolation of the transmission lines TL8 and TL9 on the rear end of the circuit that is equivalent to the RF power module HPA, and the capacitance C5 is connected between the connection node n2 formed between the transmission line paths TL8 and TL9 and a constant potential point, was tested. FIG. 7 is a Smith chart on which the impedance Z1 in view of the transmission line side from the drain terminal of the output transistor Tr3 shown in FIG. 6 is plotted.

In FIG. 7, X shows the impedance Z1 obtained when the capacitance C5 is increased gradually at the capacitance C3 shown in FIG. 6 of 0. This is a model that is equivalent to the circuit presented in the above-mentioned prior invention in which a switching circuit having a capacitor and PIN diode is connected to the output terminal of a power amplifier circuit, and the switching circuit is ON/OFF controlled depending on the communication mode. In FIG. 7, ● mark shows the impedance obtained when the capacitance C3 is increased gradually at the capacitance C5 shown n FIG. 6 of 0. This is a model that is equivalent to the circuit presented in the example shown in FIG. 3 of the present invention in which the constant switching circuit 410 is connected inside the matching circuit.

On the other hand, FIG. 8 shows a Smith chart map on which the contour line of the power efficiency in EDGE mode and the contour line of the leak power to the adjacent channel obtained when the capacitances C3 and C5 are 0 respectively in the equivalent circuit shown in FIG. 6 are drawn. In FIG. 8, chain lines a1 to a3 show the contour line of the power efficiency in EDGE mode, solid lines b1 to b4 show the contour line of the leak power to the adjacent channel in EDGE mode, and the hatched region GH shows the high efficiency region in GMSK mode. The contour lines a1, a2, and a3 of the power efficiency in EDGE mode represent the level of the power efficiency, the location nearer to the right upper corner represents the higher efficiency region, and the contour line a1 is the highest in the efficiency. Furthermore, the contour lines b1, b2, b3, and b4 of the leak power to the adjacent channel in EDGE mode represent the level of the leak power to the adjacent channel, the location nearer to the right upper corner represents the lower leak power region, and the contour line b1 is the lowest in the leak power.

An arrow corresponding to the line connecting X marks shown in FIG. 7 is represented to give the character A and an arrow corresponding to the line connecting the ● marks shown in FIG. 7 is represented to give the character B as shown in FIG. 8.

It is obvious from FIG. 8 that the arrow A is inclined to the contour lines a1, a2, and a3 of the power efficiency in EDGE mode, on the other hand the arrow B is approximately perpendicular to the contour lines a1, a2, and a3. In other words, it is likely that the arrow B directed approximately perpendicular to the contour lines a1, a2, and a3 is higher in the efficiency in comparison with the arrow A. Furthermore, it is found from FIG. 8 that the leak power to the adjacent channel in EDGE mode decreases with changing the impedance as shown with the arrow B.

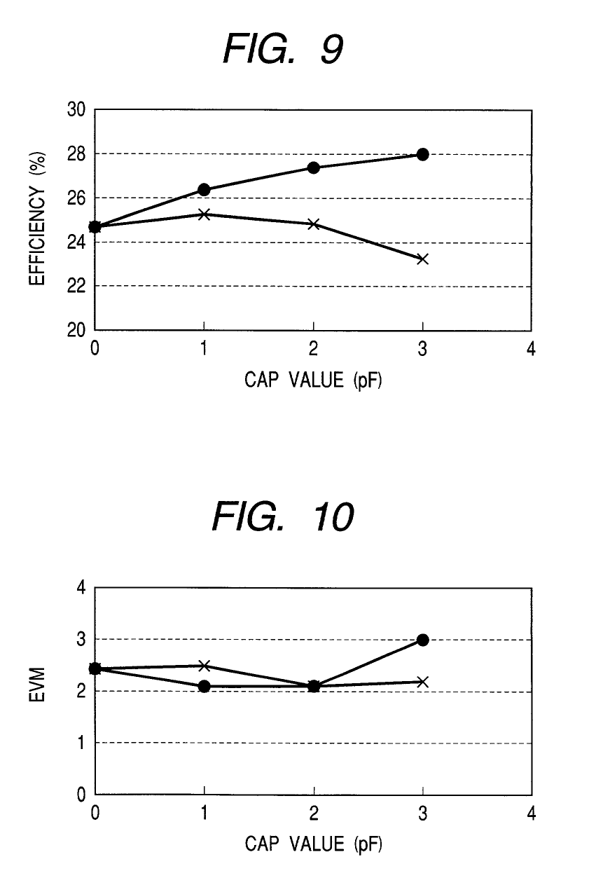

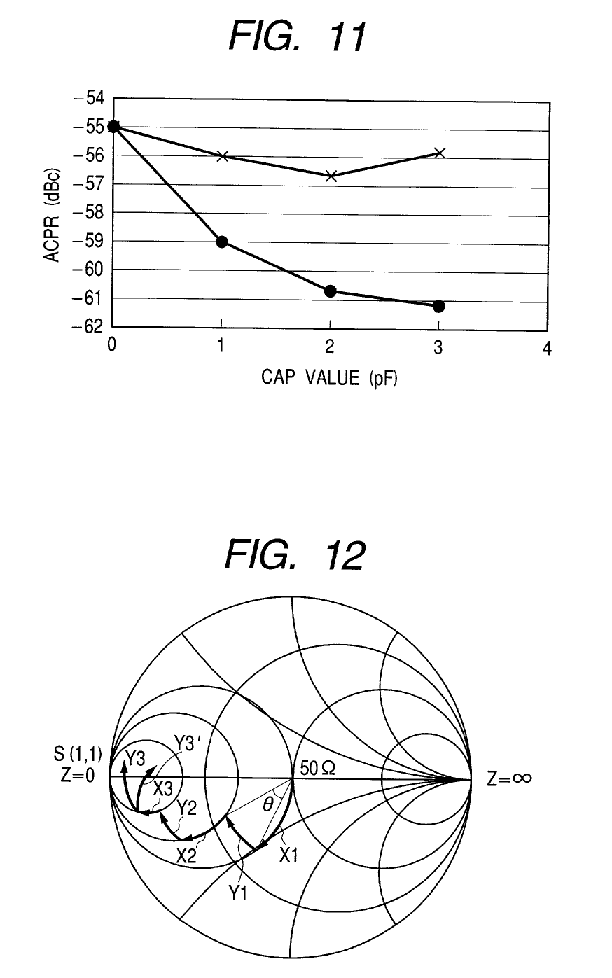

The power efficiency obtained by measurement is shown in FIG. 9 for the case in which the capacitance C5 is changed in a range from 0 to 3 pF at the constant capacitance C3 of 0 (a model equivalent to the circuit presented in the prior invention) and for the case in which the capacitance C3 is changed in a range from 0 to 3 pF at the constant capacitance C5 of 0 in the equivalent circuit shown in FIG. 6. Furthermore, FIG. 10 and FIG. 11 show EVM (Error Vector Magnitude) value and ACPR (leak power to adjacent channel) value in two models similarly. Herein, EVM value is the value that represents the deviation magnitude from the normal position of the point for representing the information position in the phase diagram having rectangular axes of I and Q in the digital modulation.

In FIG. 9 to FIG. 11, X marks represent plotted measurement result on the model that is equivalent to the circuit of the prior invention, and ● marks represent plotted measurement result on the model equivalent to the circuit of the example of the present invention. It is found from FIG. 9 that the power efficiency of the exemplary circuit of the present invention is higher, it is found from FIG. 10 that EVM value of the exemplary circuit of the present invention is not so different from that of the circuit of the prior invention, and it is found from FIG. 11 that the leak power to the adjacent channel of the exemplary circuit of the present invention is lower than that of the circuit of the prior invention.

Next, the reason why the impedance Z1 in view from the output power amplifier is inclined to the contour lines a1, a2, and a3 of the power efficiency as shown with the arrow A on the map of FIG. 8 in the case of the model that is equivalent to the circuit of the prior invention, and on the other hand the impedance Z1 in view from the output power amplifier is approximately perpendicular to the contour lines a1, a2, and a3 of the power efficiency as shown with the arrow B on the map of FIG. 8 will be described herein under.

In the case of the model that is equivalent to the circuit of the prior invention, because the switching circuit for switching the circuit constant is connected to the output terminal (50Ω) of the module, when the capacitance (corresponding to C5 in FIG. 6) in the switching circuit is changed, the impedance Z1 in view from the output power amplifier changes in clockwise direction along the circle that passes S(1,1) point and 50Ω point depending on the magnitude of the capacitance as shown with the arrow X1 on the Smith chart in FIG. 12 having the center at 50Ω. The phase (θ) of Z1 is changed in clockwise direction along the same reflection coefficient circle having the center at 50Ω as shown with the arrow Y1 at the transmission line paths TL8 and TL9 of the matching circuit.

Furthermore, Z1 is changed in clockwise direction along the circle that passes S(1,1) point and the tip of the arrow Y1 depending on the magnitude of C4 by the capacitance C4 of the matching circuit MN5. Then, the phase of Z1 is changed in clockwise direction along the co-axial circle having the center at 50Ω that passes the tip of the arrow X2 as the arrow Y2 at the transmission line paths TL4 to TL7 of the matching circuit. Furthermore, Z1 is changed in clockwise direction along the circle that passes S(1,1) point and the tip of the arrow depending on the magnitude of C2 by the capacitance C2 of the matching circuit MN4. Z1 is changed in clockwise direction along the co-axial circle having the center at 50Ω that passes the tip of the arrow X3 as the arrow Y3 at the transmission line TL2 and TL3 of the matching circuit. Herein, the direction of the arrow Y3 shown in FIG. 12 and the arrow A shown in FIG. 8 are approximately coincident as the result of comparison, and it is found that the above-mentioned hypothesis is verified.

On the other hand, in the case of the model that is equivalent to the circuit of the example of the present invention, because the switching circuit for switching the circuit constant is connected in the module, namely in the matching circuit (node n1 between MN4 and MN5), the impedance Z1 in view from the output power amplifier is at first changed in clockwise direction along the circle that passes S(1,1) point and 30Ω point depending on the magnitude of the capacitance, for example, as in the case of the arrow X1 shown in FIG. 12 by the capacitance C4 of the matching circuit MN5 on the Smith chart having the center at not the impedance of 50Ω of the output terminal but at an impedance lower than 50Ω (for example, 30Ω). The phase of Z1 is changed in clockwise direction along the same reflection coefficient circle having the center at 30Ω as in the case of the arrow Y1 shown in FIG. 12 at the transmission line paths TL6 and TL7 of the matching circuit.

Furthermore, Z1 is changed in clockwise direction along the circle that passes S(1,1) point and 30Ω point as in the case of the arrow X2 shown in FIG. 12 depending on the magnitude of C3 by the capacitance C3 of the switching circuit (140). Z1 is changed as in the case of the arrow Y2 shown FIG. 12 at the transmission line paths TL4 and TL5 of the matching circuit. Furthermore, Z1 is changed as in the case of the arrow X3 shown in FIG. 12 depending on the magnitude of C2 by the capacitance C2 of the matching circuit MN4. Then, Z1 is changed as in the case of the arrow Y3 shown in FIG. 12 at the transmission line paths TL2 and TL3 of the matching circuit.

However, in the case of the model that is equivalent to the circuit of the example of the present invention, the Smith chart has the center not at 50Ω but at 30Ω. When the Smith chart having the center at 30Ω is projected on the Smith chart having the center at 50Ω shown in FIG. 12, the arrow Y3 in the Smith chart having the center at 30Ω is equivalent to the arrow Y3′ on the Smith chart having the center at 50Ω.

The direction of the arrow Y3′ shown in FIG. 12 is approximately coincident with the direction of the arrow B shown in FIG. 8 in comparison. The above-mentioned description is the reason why the impedance Z1 in view from the output power amplifier is approximately perpendicular to the contour lines a1, a2, and a3 of the power efficiency as shown with the arrow B on the map of FIG. 8 in the case of the circuit of the example of the present invention.

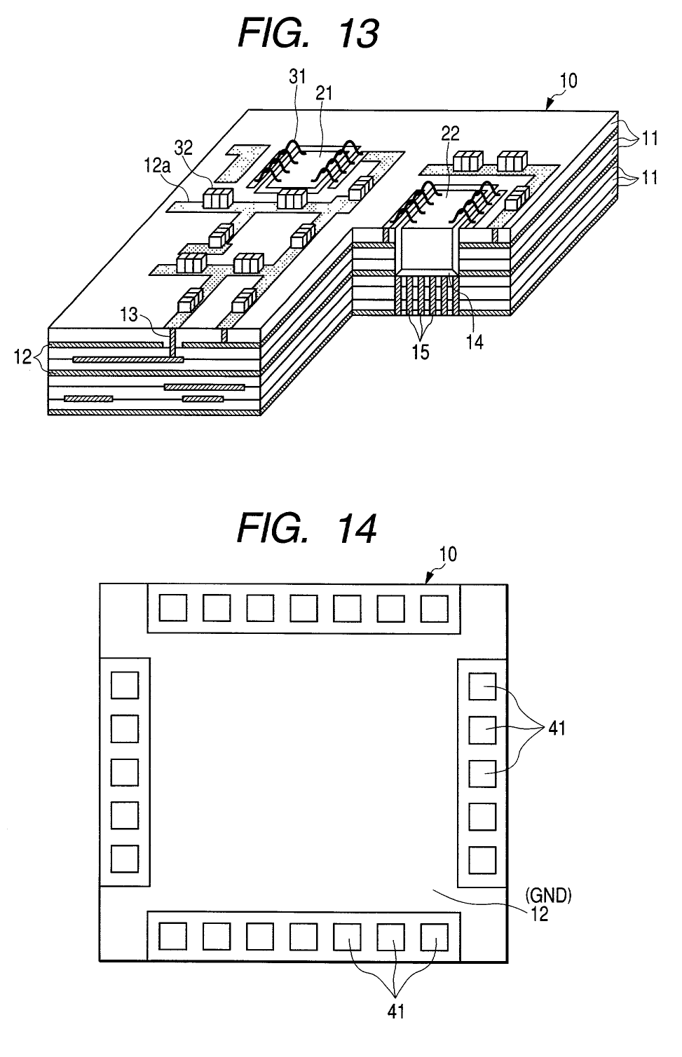

FIG. 13 shows the device structure of an exemplary RF power module. Herein, FIG. 13 is not a diagram for showing the detailed structure of the exemplary RF power module but a diagram for showing the outline of the structure from which parts and wiring are omitted partially for easy understanding.

As shown in FIG. 13, the body 10 of the module of the present example comprises a plurality of dielectric plates 11 such as ceramic plate consisting of alumina combined into one piece. On the front surface and back surface of each dielectric plate 11, a conductive layer 12 consisting of conductive material such as copper plated with gold on which a desired pattern is formed is provided. Reference numeral 12a denotes a wiring pattern comprising a conductive layer 12. Furthermore, a hole 13 called as a though hole is formed on each dielectric plate 11 to connect between conductive layer 12 or wiring pattern together on the front and back surfaces of each dielectric plate 11, and conductive material is filled in the hole.

In the case of the exemplary module shown in FIG. 13, six dielectric plates 11 are laminated, conductive layers 12 are formed on the almost entire surface of the back side of the first layer, third layer, and sixth layer from the top, which are served as the ground layer for supplying the earth potential GND respectively. Conductive layers 12 provided on the front and back surfaces of other dielectric plates 11 are served for the transmission line path. The width of the conductive layers 12 and the thickness of the dielectric plates 11 are designed so that the impedance of the transmission line path is adjusted to be 50 W.

A rectangular hole is formed on the first to third dielectric plates 11 to dispose GSM system power amplifier IC21 and DCS system power amplifier IC22. Each IC is inserted into the inside of the hole and fixed on the bottom of the hole with binder 14. Holes 15 called as via hole are formed on the fourth dielectric plate 11 located at the position corresponding to the bottom of the hole and on dielectric plates 11 laminated under the fourth dielectric plate 11, and conductive material is filled in the holes. The conductive material filled in the via holes is served to transfer the heat generated from the IC21 and IC22 to the lowermost conductive layer to dissipate the heat and improve the thermal efficiency.

Electrodes on the top surface of the IC21 and IC22 and the predetermined conductive layers 12 are connected electrically by means of bonding wire 31. Furthermore, on the surface of the first layer dielectric plate 11, a plurality of chip-type electronic apparatus 32 such as capacitance elements, resistor elements, diode elements, and transistor elements are mounted to form the above-mentioned matching circuits MN4 and MN5 and the circuit constant switching circuit 410. Otherwise, the capacitance H elements among these elements may be formed in the internal of the substrate by use of conductive layers on the front and back surfaces of dielectric plates 11 instead of use of the electronic apparatus.

The module has an external terminal served for mounting the module of the present example on a printed wiring board by connecting electrically each other. The external terminal is an electrode pad 41 comprising a conductive layer that is formed in a predetermined shape, and the external terminal is disposed on the back surface of the module body 10 as shown in FIG. 13. The external terminal is structured so as to be mounted on the printed wiring board with interposition of a solder ball between the electrode pad and the corresponding portion located on the printed wiring board of the system (a portion of the wiring or conductive layer connected to the wiring).

The layout and the configuration of the electrode pad 41 shown in FIG. 14 only shows an example, and that is by no means limited to the example. Furthermore, the conductive layer 12 that is served as the ground layer for supplying the earth potential is formed on almost entire region excepting the surface of the electrode pad 41 as described hereinabove in FIG. 14.

The invention accomplished by the inventors of the present invention has been described based on the example in detail, however, the present invention is by no means limited to the above-mentioned example, and as a matter of course various modifications may be applied without departing from the sprit and the scope of the present invention. For example, a coupler that detects the output level of the power amplifier and APC (Automatic Power Control) circuit that controls the bias voltage of the output transistor element based on the output of the coupler may be provided though these components are not shown in the system of FIG. 1.

Furthermore, the case in which two step matching circuits MN4 and MN5 are connected between the output transistor Tr3 and the output terminal Pout is presented in the example shown in FIG. 3, but the case in which three or more steps of matching circuits are connected may be employed.

Furthermore, the case in which the output power amplifier and the antenna switch circuit are incorporated separately in the modules 400 and 100 is described in the above-mentioned example, but the case in which the RF power module 400 and the antenna switch module 100 used in the above-mentioned example are incorporated in one module may be employed in the present invention. In any case, the circuit constant switching circuit is connected to the point of the impedance that is smaller than 50Ω on the middle way of the transmission line before the output terminal having the impedance of 50Ω of the matching circuit in the present invention.

A single band type cellular phone is exemplified in the example for description, but the present invention can be applied also to a multi-band type cellular phone. In detail, in the system shown in FIG. 1, a plurality of sets, each of which comprises an RF power module 400, a filter FLT, and a low noise amplifier LNA, are provided and also a diplexer for branching a signal including different frequency bands is provided so that the signal is switched. Thereby, a multi-band type cellular phone is realized.

The case in which the present invention is applied to the dual-mode cellular phone that is capable of transmission/reception in two modulation systems, namely GMSK and EDGE, which is the application field of the background for inventing the present invention accomplished by the inventors, is described hereinbefore. However, application of the present invention is by no means limited to the case, and the present invention may be applied to various wireless communication systems such as multi-band cellular phones and mobile telephones that are capable of transmission/reception by means of another modulation system and a system that involves three or more modulation modes.

The effect obtained by applying the typical invention out of inventions disclosed in the present patent application is described herein under.

In detail, the power efficiency of an RF power module of a wireless communication system that operates in the saturation operation mode and the linear operation mode of the transistor of the output power amplifier can be improved. Furthermore, an RF power module that is capable of obtaining high output power with reduced power consumption is realized, and a long talking time or long waiting time can be realized by using a wireless communication system such as a cellular phone that is provided with the above-mentioned module.

What is claimed is:

1. An electronic apparatus used for a wireless communication system in which at least an output power amplifier and an impedance matching circuit are mounted on one insulating substrate and the impedance of an output terminal of the impedance matching circuit is set to 50Ω, wherein a switching circuit that changes the circuit constant of the impedance matching circuit depending on the operation condition is provided at the point of the impedance that is lower than the impedance of the output terminal in the impedance matching circuit.

2. An electronic apparatus used for a wireless communication system in which at least an output power amplifier and an impedance matching circuit are mounted on one insulating substrate and the impedance of an output terminal of the impedance matching circuit is set to 50Ω, wherein a switching circuit that changes the high frequency impedance value in view of the impedance matching circuit side from the output power amplifier depending on the operation condition is provided at the point of the impedance that is lower than the impedance of the output terminal in the impedance matching circuit.

3. An electronic apparatus used for a wireless communication system in which at least an output power amplifier and an impedance matching circuit are mounted on one insulating substrate, the impedance of an output terminal of the impedance matching circuit is set to 50Ω, and the final step output transistor of the output power amplifier operates in the first operation mode where the final step output transistor operates in the saturation region and in the second operation mode where the final step output power transistor operates in the linear region, wherein a switching circuit that changes the circuit constant of the impedance matching circuit depending on the operation mode is provided at the point of the impedance that is lower than the impedance of the output terminal in the impedance matching circuit.

4. An electronic apparatus used for a wireless communication system in which at least an output power amplifier and an impedance matching circuit are mounted on one insulating substrate, the impedance of an output terminal of the impedance matching circuit is set to 50Ω, and the final step output transistor of the output power amplifier operates in the first operation mode where the final step output transistor operates in the saturation region and in the second operation mode where the final step output power transistor operates in the linear region, wherein a switching circuit that changes the high frequency impedance value in view of the impedance matching circuit side from the output power amplifier depending on the operation mode is provided at the point of the impedance that is lower than the impedance of the output terminal in the impedance matching circuit.

5. The electronic apparatus according to claim 3, wherein the first operation mode is a mode for amplifying a high frequency transmission signal according to GMSK modulation system and the second operation mode is a mode for amplifying a high frequency transmission signal according to EDGE modulation system.

6. The electronic apparatus according to claim 1, wherein the switching circuit includes a switching means and a capacitance element connected in series between the transmission path of the signal and a constant potential point.

7. The electronic apparatus according to claim 6, further including a terminal for receiving a voltage or a signal that controls the switching circuit.

8. A wireless communication system comprising:
a first electronic apparatus, in which at least an output power amplifier and an impedance matching circuit are mounted on one insulating substrate, and which has the first operation mode where the output transistor of the output power amplifier operates in the saturation region and the second operation mode where the output power transistor operates in the linear region, and is provided with a switching circuit that changes the circuit constant of the impedance matching circuit or the high frequency impedance value in view of the impedance matching circuit side from the output power amplifier depending on the operation mode;
a second electronic apparatus having an antenna terminal having the impedance of 50Ω and a switching circuit for switching a transmission/reception signal;
an antenna connected to the antenna terminal;
a low noise amplifier for amplifying a signal received from the antenna terminal;
a high frequency processing circuit for modulating a transmission signal to be amplified by means of the output power amplifier and for demodulating a received signal amplified by means of the low noise amplifier; and
a base band circuit that converts an audio signal to a base band signal to supply the base band signal to the high frequency processing circuit, and converts the received signal demodulated by means of the high frequency processing circuit to an audio signal.

9. The wireless communication system according to claim 8, wherein the first operation mode is a mode for amplifying a high frequency transmission signal according to GMSK modulation system and the second operation mode is a mode for amplifying a high frequency transmission signal according to EDGE modulation system.

10. The wireless communication system according to claim 9, wherein the switching circuit includes a switching means and a capacitance element connected in series between the transmission path of the signal and a constant potential point.

11. The wireless communication system according to claim 10, wherein the first electronic apparatus has a terminal for receiving a voltage or a signal that controls the switching circuit, and the voltage or the signal for controlling the switching circuit is supplied from the base band circuit.

12. The wireless communication system according to claim 11, wherein the second electronic apparatus has a terminal for receiving a voltage or a signal that controls the switching circuit, and the voltage or the signal for controlling the switching circuit is supplied from the base band circuit.

13. The wireless communication system according to claim 12, wherein the impedance of the output terminal of the impedance matching circuit is set to 50Ω, and the switching circuit is connected to the point of the impedance that is lower than the impedance of the output terminal in the impedance matching circuit.
